(19) United States
(12) Patent Application Publication
(10) Pub. No.: US 2024/0278595 A1
(43) Pub. Date: Aug. 22, 2024

(54) FACE TO RIM REINFORCING CONNECTOR OF A COMPOSITE WHEEL

(71) Applicant: Carbon Revolution Limited, Waurn Ponds, Victoria (AU)

(72) Inventors: Jayden Chee, Highton, Victoria (AU); Timothy Corbett, Torquay, Victoria (AU); Ashley James Denmead, Belmont, Victoria (AU); Eden Kwok, Newtown, Victoria (AU); Marcus Presser, Highton, Victoria (AU); Nicholas Taylor, Waurn Ponds, Victoria (AU); Barry Trippit, Glen Iris, Victoria (AU)

(73) Assignee: Carbon Revolution Limited, Waurn Ponds, Victoria (AU)

(21) Appl. No.: 18/571,359

(22) PCT Filed: Jun. 17, 2022
(86) PCT No.: PCT/AU2022/050610

§ 371 Date: Dec. 18, 2023

(30) Foreign Application Priority Data
Jun. 18, 2021 (AU) 2021901838

(51) Int. Cl. B60B 3/10; B60B 3/04; B60B 5/02

(52) U.S. Cl. CPC B60B 3/10; B60B 3/041; B60B 5/02

(57) ABSTRACT

A spoke-to-rim reinforcing connector of a composite wheel. The composite wheel has a rim portion with a complementary rim fibre layup and a circumferential axis, and a face portion with a hub and spokes interconnecting the rim portion and the hub, each spoke having a complementary spoke fibre layup. The spoke-to-rim reinforcing connector comprises at least one spoke saddle and at least two rim tabs. The spoke saddle has a seat portion extending around an end portion, about the spoke axis, and over a face surface of the spoke fibre layup, and at least two spoke legs that extend over the sides of the spoke fibre layup. Each rim tab extends from a spoke leg perpendicularly to the spoke axis and is configured to be incorporated into the rim fibre layup. The connector has a continuous body having a fibre orientation extending perpendicular to the spoke axis.

### PRIORITY CROSS-REFERENCE

The present application claims priority from Australian provisional patent application No. 2021901838 filed on 18 Jun. 2021, the contents of which are to be understood to be incorporated into this specification by this reference.

### TECHNICAL FIELD

The present invention generally relates to a connection architecture between the face portion (and the spoke portion thereof) and the rim portion of a composite wheel. The invention is particularly applicable to a spoke to rim reinforcing connector which is located in the connection architecture between the face portion and the rim portion of a composite wheel, and in particular carbon fibre wheels for vehicles and/or aeroplanes. It will therefore be convenient to hereinafter disclose the invention in relation to that exemplary application. However, it is to be appreciated that the invention is not limited to that application and could be used to connect face and rim portions of a large variety of wheels.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

A composite wheel generally includes two main sections, a rim portion and a face portion. The rim portion comprises a generally annulus or ring-shaped structure configured to receive and seat a tyre. The face portion includes a hub which is used to fix the wheel to the vehicle, and a connection structure such as a series of spokes or a disc which extends between and interconnects the hub and the rim. Lateral, vertical and torsional loads are transmitted through the tyre to the rim portion of the wheel which then produce bending and torsional stresses in the connection structure.

The Applicant has produced a one-piece composite wheel, which is described, for example, in International Patent Publication WO2010/025495A1 and International Patent Publication No. WO2019/033169A1. The creation of a one-piece composite wheel generally necessitates use of a separate rim portion mould and associated reinforcement, and a face portion mould and associated reinforcement. The separate rim and face mould portions are interconnected for a final moulding process which allows the overall composite wheel to be integrally formed. A stiff, strong connection between the rim portion and the face portion, in particular the connection between the spokes and the rim, is required to provide a mechanically efficient structure having stiffness and strength and also efficiently transmit loads generated between the tyre and road, through the rim and spokes.

This connection and load transfer structure is currently achieved in the Applicant's composite wheels using folding tabs that are inserted between the ends of the spoke fibre layup and into the rim fibre layup. These folding tabs are incorporated in adjacent plies of the rim fibre layup to hold the laminate structure together. One form of this connection is detailed in Applicant's international patent publication WO2014/165895A9, the contents of which are incorporated into this specification by this reference.

However, the current fibre layup of the Applicant's wheel does not have a specific or effective means for transferring load between the rim portion and parts of the back of the spokes, for example, face structures in the back of the spoke radius of the composite wheel. Certain loading conditions on the composite wheel do not provide optimal load transfer from the rim portion through the spokes to the wheel mount of the vehicle, which can produce high stress regions in the spokes.

It would therefore be desirable to provide an improved or alternate connection between the rim portion and the face portion of a composite wheel, and in particular an improved connection between the spokes and the rim of a composite wheel.

### SUMMARY OF THE INVENTION

A first aspect of the present invention relates to a reinforcing connector for a connection between a rim portion and a face portion of a composite wheel, and more particularly a connection between a spoke and a rim portion of that composite wheel.

The first aspect of the present invention provides a spoke to rim reinforcing connector of a composite wheel,

the composite wheel having a rim portion comprising a shaped annulus formed about a central axis of rotation of the composite wheel and having a circumferential axis extending circumferentially about the central axis and around the rim portion, and a face portion comprising a generally circular shaped hub and a plurality of spokes which extend along a spoke axis that extends generally radially to the circumferential axis, the plurality of spokes extending between the rim portion and the hub to interconnect the rim portion and the hub, each spoke having an outwardly extending face surface, an opposing back surface and side surfaces therebetween,

the rim portion having a complementary rim fibre layup therein and each spoke has a complementary spoke fibre layup therein,

the spoke to rim reinforcing connector comprising:

at least one spoke saddle comprising a seat portion which extends around an end portion of the spoke fibre layup about the spoke axis and over the face surface of the spoke fibre layup, and at least two spoke legs that extend over the sides of the spoke fibre layup; and

at least two rim tabs, each rim tab extending from a spoke leg generally perpendicularly to the spoke axis, each rim tab configured to be incorporated into the rim fibre layup of the rim portion of the composite wheel,

wherein the connector comprises a continuous body having a fibre orientation that extends substantially perpendicular to the spoke axis.

The spoke to rim reinforcing connector of the present invention therefore has a continuous configuration within the fibre layup of the composite wheel that starts in the rim (first rim tab), wraps around the sides and face of the spoke (the spoke saddle), and ends back in the rim (second rim tab). The configuration of the spoke to rim connector enables a composite wheel to be constructed with fibre alignment with the load paths through the rim to spoke connection, reinforcing the spoke to rim connection with a body that assists with effective transfer of load between the rim and face structures of that composite wheel.

The fibre orientation of the connector is substantially perpendicular to the spoke axis in the spoke saddle and the rim tabs of the connector. The connector preferably has a continuous fibre orientation therethrough that extends substantially perpendicular to the spoke axis. The connector can therefore have a continuous fibre orientation throughout the connector's configuration that starts in the rim fibre layup (rim tab), wraps around the face of the spoke fibre layup (spoke saddle), and ends back in the rim fibre layup (rim tab).

It is to be understood that a fibre layup of a particular section of the composite wheel, for example the spoke fibre layup and the rim fibre layup, is the comprising fibre architecture of that particular section which is formed (i.e. laid up) to provide the shape, configuration and reinforcement structure therein. The fibre layup is generally provided in the underlying shape of the particular section, and includes fibres in the form of prepregs, semi-pregs, woven or non-woven fabrics, mats, pre-forms (including Tailored fibre placement preforms), pre-consolidated pre-forms, individual or groups of fibres, tows, tow-pregs, or the like (as discussed below), inserts and the like. The fibres are generally orientated to provide a suitable reinforcement and/or load transfer structure tailored to the requirements of that particular section of the composite wheel.

The spoke to rim reinforcing connector is preferably formed from a shaped sheet of material, configured to engage and be integrated into the fibre layup of the adjoining rim portions and spoke sections of the composite wheel, whilst providing suitable fibre alignment with the load paths through the rim to spoke connection. Each of the sections can therefore be formed from a substantially planar body, preferably a sheet of material, more preferably a shaped sheet of material. For example, the spoke saddle preferably comprises a planar body wrapped around the sides and face surface of the end portion of the spoke fibre layup of a spoke. Similarly, each rim tab preferably comprises a substantially planar body configured to be generally parallel aligned with the annular body of the rim fibre layup of the rim portion of that composite wheel.

Each of the rim tabs is configured to be integrated into the rim fibre layup of the rim portion of the composite wheel. Therefore, the substantially planar body of each rim tab may include a planar face which is orientated about 90 degrees to a planar face of the spoke legs from which the rim tab is connected to and extends from.

Each rim tab is also preferably configured to wrap around the back surface of each spoke fibre layup, to complete coverage around the spoke fibre layup and from the rim fibre layup under each spoke, through to the back surface of each spoke fibre layup. This configuration enables fibre alignment between the back surface of the spoke and rim portion to accommodate load paths in that area through the rim to spoke connection. In these embodiments, each rim tab is configured to abut an adjacent rim tab under the back surface of the spoke fibre layup of the composite wheel. Adjoining rim tabs are preferably configured to form a continuous cover that extends over the section of the rim fibre layup under the back surface of the spoke of the composite wheel.

To assist with load transfer from the rim portion to the back surface of each spoke, each rim tab preferably includes a spoke section configured to extend along a portion of the rim fibre layup that is adjacent to and under the back surface of the spoke fibre layup of the composite wheel. Load transfer can be further assisted by the spoke section of each rim tab, and preferably a top section of each rim tab, being configured to curve towards a back surface of the spoke fibre layup. In such embodiments, the spoke section of each rim tab is preferably curved to wrap around the back surface of the spoke fibre layup to facilitate transition of the fibre orientation in the spoke section from substantially perpendicular to the spoke axis towards being more spoke axis aligned.

The rim tab therefore provides a section which is laid up into the rim fibre layup of the composite wheel and another portion (spoke section of the rim tab) which starts to transition into and wraps around at least part of the back surface of the spoke fibre layup. This facilitates a curved transition in the fibre orientation of that rim tab from substantially perpendicular to the spoke axis when in the rim portion towards being more spoke axis aligned when attached to and or laid up in the back surface of the spoke. Overall, the fibre orientation of the connector is perpendicular to the spoke axis in the spoke saddle (face portion) of the connector and in the body of each of the rim tabs, but can then be designed to wrap around at least part of the back of spoke. Again, this assists in load transfer between the rim portion and the back surface of each spoke.

Thus, when the connector includes the features above and is located in the fibre layup of a composite wheel, the connector has a configuration that fully loops or encircles around the end section of the spoke fibre layup of that composite wheel. The material of the connector starts under the back of the spoke in the rim fibre layup (rim tab), wraps around the face of the spoke fibre layup (spoke saddle), and ends back in the rim fibre layup under the back surface of the spoke in the rim (rim tab) with the two rim tabs abutting or otherwise joining under the back surface of that spoke.

The spoke to rim reinforcing connector can have any suitable shape and configuration that is able to engage and be integrated into the adjoining rim fibre layup and spoke fibre layup of the composite wheel.

The spoke saddle extends around an end portion of the spoke fibre layup about the spoke axis, preferably generally circumferentially relative to the spoke axis. Thus, the spoke saddle can comprise a generally curved planar sheet, which preferably forms a generally arched shape over the spoke fibre layup. In some embodiments, the spoke seat of each spoke saddle includes a top section shaped to cover a portion of the top face of the spoke fibre layup proximate to where the spoke connects to the rim portion, the top section of the spoke seat having a generally rectangular or trapezoidal shape.

Each spoke saddle is located at and over the proximal end of the spoke fibre layup located at an interface between the rim portion and spoke portion of the composite wheel. The connector is therefore located at the outboard end of the spoke fibre layup where the load transfer between the rim and face structures are required.

Each spoke leg extends over a side of the spoke fibre layup and preferably generally perpendicularly away from the face surface of the spoke fibre layup of the spoke. Each of the at least two spoke legs therefore extend over opposing sides of the spoke fibre layup, ensuring each side is covered by at least one spoke leg. Like the spoke seat, the spoke legs preferably comprise a substantially planar body, preferably a shaped sheet, that extends over the sides of the spoke fibre layup of the spoke. In embodiments, the spoke legs of each spoke saddle have a generally triangular shape.

The spoke legs may additionally include at least one edge flange portion which is configured to extend at an angle outwardly of the face of the spoke legs and towards the rim fibre layup of the composite wheel. The edge flange portions assist in load transfer between the rim portion and face structures of the side surfaces of the spoke of the composite wheel into which the connector is to be incorporated.

The rim tabs preferably comprise a substantially planar body, preferably a shaped sheet. In many embodiments, each rim tab comprises a generally rectangular body connected to a trapezoidal shaped spoke section. Each rim tab is connected to the respective spoke leg of the spoke saddle through a joint about which each rim tab is angled between 80 to 100 degrees, preferably around 90 degrees relative to the face of the spoke legs. Each joint preferably comprises at least one fold line or bend line. It should be appreciated that the joint preferably comprises an integral joint between each rim tab which is connected to the spoke seat. This joint generally comprises a bend or transition line between those two parts formed in the continuous material or body forming the spoke to rim reinforcing connector.

The spoke to rim reinforcing connector may be formed—for example cut—from uniaxial fabric. In these embodiments, the spoke to rim reinforcing connector comprises a fabric sheet, preferably a uniaxial carbon fibre fabric sheet. The spoke to rim reinforcing connector is typically formed as an integral body, formed from a single sheet or ply of material. In some embodiments, the spoke to rim reinforcing connector can be formed from multiple layers preformed together as a three-dimensional shape. The spoke to rim reinforcing connector preferably comprises an integral or continuous uniaxial carbon fibre fabric.

In some embodiments, the spoke saddle and the rim tabs may be formed in an integral material sheet. In other embodiments, the spoke saddle and rim tabs may be formed as separate sections that are physically interconnected, for example stitched or woven together. This type of interconnection can be advantageous in those embodiments where the first section and second section of each layer are formed from fabrics, the fabric ends being woven, stitched together or otherwise joined to strengthen the intralayer bond between these sections.

While several uniaxial fabric arrangements could be used, such as stitch bonded, or weft stabilised uniaxial fabrics, the preferred arrangement of the rim to spoke connector comprises at least one tailored fibre preform having a desired shape and fibre orientation. Preferably, the spoke to rim reinforcing connector comprises a Tailor Fibre Placement (TFP) preform. A TFP preform uses tailor fibre placement technology to enable optimal fibre alignment and thickness changes. This ensures the fibre direction is maintained through the preforming and layup operations. A TFP also provides for more flexibility in ply thickness. A TFP allows for fibre alignment not possible in a flat cut ply. The spoke to rim reinforcing connector is typically formed as an integral body, formed from a single ply of material. However, it should be appreciated that in embodiments the spoke to rim reinforcing connector can also be formed from two or more, preferably multiple plies of materials, each having the described configuration.

A second aspect of the present invention provides a connection between a rim portion and a face portion of a composite wheel having a fibre layup that includes at least one spoke to rim reinforcing connector according to the first aspect of the present invention.

The spoke to rim reinforcing connector is preferably located at an outboard end of the spoke fibre layup where the load transfer between the rim and face structures of the spoke is required. The outboard end of the spoke fibre layup is located proximate the intersection between the rim portion and spoke of the composite wheel.

It should be appreciated that the spoke fibre layup can include one or more spoke to rim reinforcing connectors according to the first aspect of the present invention within the layers. In some embodiments, the fibre layup of the connection between a rim portion and a face portion of a composite wheel having at least two spoke to rim reinforcing connectors according to the first aspect of the present invention. In embodiments, multiple spokes to rim reinforcing connectors are included in that layup. In some embodiments, multiple spokes to rim reinforcing connectors (of a single or multiple layer construction) could be positioned at various points in that fibre layup. For example, three spoke to rim reinforcing connectors could be positioned at the bottom, middle and top of the spoke fibre layup.

The fibre layup of the composite wheel is preferably un-infused or pre-impregnated i.e. dry fibre only with no resin when the spoke to rim reinforcing connector is located in the connection between a rim portion and a face portion of a composite wheel. Each of the rim portion and the face portion is preferably at least partially uncured, and preferably substantially uncured at the time when the connection is prepared. The connection between a rim portion and a face portion of a composite wheel can therefore be integrated in the fibre layup of the rim portion and the fibre layup of the face portion of a composite wheel prior to resin injection and curing processes of forming the composite wheel. When the moulding (typically a RTM moulding process (see below) is undertaken, the connection further comprises a matrix material enveloping the fibre layup of the connection. Similarly, the matrix material envelops the fibre layup of the composite wheel. The matrix material preferably comprises a resin based on unsaturated polyester, polyurethane, polyvinyl ester, epoxy, thermoplastics, similar chemical compounds or combinations thereof.

The Applicant's composite wheel is preferably formed as an integrally formed composite wheel, with the rim portion and face portion of the composite wheel integrally formed and connected. The connection portion of the composite wheel is therefore also preferably integrally formed with the composite wheel.

A third aspect of the present invention provides a composite wheel including a spoke to rim reinforcing connector according to the first aspect of the present invention.

A fourth aspect of the present invention provides a composite wheel including a connection according to the second aspect of the present invention.

In both the third aspect and the fourth aspect of the present invention, the composite wheel preferably comprises a carbon fibre wheel.

In embodiments, the fourth aspect of the present invention can provide a composite wheel having a rim portion comprising a shaped annulus formed about a central axis of rotation of the composite wheel and having a circumferential axis extending circumferentially about the central axis and around the rim portion, and a face portion comprising a generally circular shaped hub and a plurality of spokes which extend along a spoke axis that extends generally radially to the circumferential axis, the plurality of spokes extending between the rim portion and the hub to interconnect the rim portion and the hub, each spoke having an outwardly extending face surface, an opposing back surface and side surfaces therebetween,

wherein the rim portion has a complementary rim fibre layup therein and each spoke has a complementary spoke fibre layup therein,

and wherein the composite wheel includes a connection between a rim portion and a face portion of a composite wheel having a fibre layup that includes a spoke to rim reinforcing connector comprising:

at least one spoke saddle comprising a seat portion which extends around an end portion of the spoke fibre layup and over the face surface of the spoke fibre layup, and at least two spoke legs that extend over the sides of the spoke fibre layup; and

at least two rim tabs, each rim tab extending from a spoke leg generally perpendicularly to the spoke axis, each rim tab configured to be incorporated into the rim fibre layup of the rim portion of the composite wheel,

wherein the connector comprises a continuous body having a fibre orientation that extends substantially perpendicular to the spoke axis.

A wide variety of fibres may be used in the present invention, including but not limited to fibres selected from the group consisting of carbon fibres, glass fibres, aramid fibres, synthetic fibres such as acrylic, polyester, PAN, PET, PE, PP or PBO-fibres, or the like, bio fibres such as hemp, jute, cellulose fibres, or the like, mineral fibres for example Rockwool or the like, metal fibres for example steel, aluminium, brass, copper, or the like, boron fibres or any combination of these.

Once moulded and formed into a composite wheel, the connection, the rim portion and the face portion comprise a matrix material, such as resin, metal, and fibres. The fibres may be provided in any suitable form including in prepregs, semi-pregs, woven or non-woven fabrics, mats, pre-forms, pre-consolidated pre-forms, individual or groups of fibres, tows, tow-pregs, or the like. During layup (preparing up to the point before consolidation and/or setting, curing or the like of the matrix material) of a connection, the matrix material need not be comprised in the layers comprising fibres (e.g. a prepreg or semi-preg) or between the layers comprising fibres. However, the matrix material should form a continuous matrix after setting occurs.

It should be appreciated that the composite wheel comprising a spoke to rim connector according to the first aspect of the present invention can be formed by any suitable process. That process can be a manual layup process, an automated layup process or a combination of manual and automated processes.

The present invention can therefore provide in a fifth aspect, a method for connecting a rim portion and a face portion of a composite wheel comprising:

forming a face portion fibre layup having a selected carbon fibre layup which includes a generally circular shaped hub and a plurality of spokes which extend along a spoke axis from the hub and a connection element for interconnection into a rim portion fibre layup;

providing an annular mould tool having an annular mould face shaped to provide the designed configuration of the rim portion;

locating connection elements between the rim fibre layup of the composite wheel and the face portion fibre layup of the composite wheel onto the annular mould face;

locating a spoke to rim connector according to the first aspect of the present invention about the connection elements, positioning the spoke saddle of each connector over an end portion of the fibre layup of each spoke, and each rim tab in alignment with the rim fibre layup of the composite wheel; and

forming the rim portion fibre layup to incorporate each rim tab therein.

It should be appreciated that the rim portion and face portion can be formed as taught in the Applicant's International Patent Publication No. WO2019/033169A1 the contents of which should be understood to be incorporated herein by this reference.

The fibres of the connection are preferably injected and/or impregnated with matrix material and then cured and/or set. The method therefore preferably further includes the steps of:

providing a matrix material in contact with each of the layers of the connection; and

curing the connection.

It should be appreciated that curing of the matrix material and the associated part such as the connection, wheel or similar encompasses curing, setting, drying or similar processes.

The composite wheel is preferably formed as a unitary body. This typically involves simultaneous injection and/or impregnation of matrix material and then curing, setting or the like of each portion of the composite wheel. In such embodiments, each of the rim portion and the face portion are preferably at least partially uncured at the time when the connection is prepared. The connection portion is preferably integrally formed with the composite wheel. In such embodiments, each of the rim portion and the face portion are preferably at least partially uncured at the time when the connection therebetween is prepared. The method therefore preferably further includes the steps of:

concurrently providing a matrix material in contact with each rim portion and the face portion of the wheel; and

co-curing the rim portion and the face portion of the wheel.

Where the matrix material comprises a resin, a variety of resin delivery systems can be used with the method of the second aspect. In some embodiments, at least a part of the resin is provided by Resin Infusion and/or Resin Transfer Moulding and/or Vacuum Assisted Resin Transfer Moulding.

Once moulded and formed into a composite wheel, the rim portion and the face portion and connection therebetween comprise a matrix material, such as resin, metal, and fibres. During layup (preparing up to the point before consolidation and/or setting, curing or the like of the matrix material) of a connection, the matrix material need not be comprised in the layers comprising fibres (e.g. a prepreg or semi-preg) or between the layers comprising fibres. However, the matrix material should form a continuous matrix after setting occurs.

The matrix material need not be comprised in or between two adjacent layers comprising fibres. In a preferred embodiment an adhesive may in this case be provided between at least some of such pairs of layers to at least temporarily and at least partially fix the adjacent layers comprising fibres.

The fibres of the connection, rim portion and/or face portion are preferably injected and/or impregnated with matrix material and then cured, set or the like. The connection therefore preferably further comprises a matrix material enveloping the comprising fibres. Any suitable matrix material can be used. In some embodiments, a resin is used. The resin is preferably based on unsaturated polyester, polyurethane, polyvinyl ester, epoxy, thermoplastics, similar chemical compounds or combinations thereof. In a preferred embodiment, the resin is epoxy-based.

The carbon fibre layup of the composite wheel is preferably provided as at least one of prepregs, semi-pregs, woven or non-woven fabrics, mats, preforms, pre-consolidated pre-forms, individual or groups of fibres, tows, or tow-pregs. The fibre elements of the fibre layup of the composite wheel can be provided as at least one fabric sheet, preferably a multi-axial fabric. However, it should be appreciated that the ply can have any suitable weave or form, for example a plain weave ply or a twill weave ply.

It is to be understood that prepreg refers to a substantially or fully impregnated collection of fibres, fibre tows, woven or non-woven fabric or the like. Similarly, it is to be understood that semi-preg refers to a partially impregnated collection of fibres or fibre tows. The partial impregnation provides for enhanced removal of gas through or along the dry fibres during consolidation and/or curing. An example of a semi-preg is a partially impregnated layer of fibres.

It is to be understood that woven and non-woven fabrics are collections of individual fibres or fibre tows which are substantially dry, i.e. not impregnated by a matrix material, such as resin. It should also be understood that fibre tows are bundles of a large number of individual fibres, for example 1000's, 10000's or 100000's of fibres. Tow-pregs are at least partially impregnated fibre tows.

The laid-up material is typically infused with the resin so that that resin permeates through the material. The composite wheel includes the resin (which binds the fibres and other comprising material together) once moulded and formed into the composite wheel. During layup (preparing up to the point before consolidation and/or setting, curing or the like of the resin), the resin need not be comprised in the layers which include the fibres (e.g. a prepreg or semi-preg) or between the layers comprising fibres. However, the resin should form a continuous matrix after setting occurs.

It should be appreciated that curing of the resin and the associated part such as the composite wheel or fascia layer encompasses curing, setting, drying or similar processes.

A variety of resin delivery systems can be used. In some embodiments, at least a part of the resin is provided by Resin Infusion and/or Resin Transfer Moulding and/or Vacuum Assisted Resin Transfer Moulding. The fascia layer can therefore be formed by various resin based moulding systems known in the art. One preferred system is resin transfer moulded (RTM).

The fibres and fibre elements of the fibre layup of the composite wheel substantially comprise carbon fibre fibres. However, it should be appreciated that a wide variety of other or alternate fibres may also be included in the fibre layup of the composite wheel in the present invention, including but not limited to fibres selected from the group consisting of glass fibres, aramid fibres, synthetic fibres such as acrylic, polyester, PAN, PET, PE, PP or PBO-fibres, or the like, Kevlar, bio fibres such as hemp, jute, cellulose fibres, or the like, mineral fibres for example Rockwool or the like, metal fibres for example steel, aluminium, brass, copper, or the like, boron fibres or any combination of these. In a preferred embodiment, the fibres comprise carbon fibres or a mixture of carbon fibres with one or more of the above types of fibres.

The fibre elements may be provided in any suitable form including in prepregs, semi-pregs, woven or non-woven fabrics, mats, pre-forms, pre-consolidated pre-forms, individual or groups of fibres, tows, tow-pregs, or the like. In embodiments, the fibre elements are provided as at least one fabric sheet, preferably a multi-axial fabric. During layup (preparing up to the point before consolidation and/or setting, curing or the like of the resin) of a connection, the resin need not be comprised in the layers comprising fibres (e.g. a prepreg or semi-preg) or between the layers comprising fibres. However, the resin should form a continuous matrix after setting occurs.

It should be understood that the term “composite” herein denotes any type of composite material comprising fibres, cured or uncured, irrespective of the structure being layered or not. Furthermore, pre-forms and pre-consolidated pre-forms cured or uncured are important subgroups of composite materials and bodies.

It should also be understood that the term “cured” in “cured composite fibre material” indicates that the composite fibre material has undergone at least a partial curing process to harden, cure or set a curable resin in the composite fibre material.

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of a composite wheel including a connection between a face portion and a rim portion thereof that includes a spoke to rim reinforcing connector according to one embodiment of the present invention.

FIG. 2 is a more detailed view of the rim to face connection region of the composite wheel shown in FIG. 1.

FIG. 3A provides a perspective view of a spoke to rim connector according to an embodiment of the present invention positioned in the spoke and rim fibre layup of the composite wheel shown in FIGS. 1 and 2.

FIG. 3B provides a cross-sectional perspective view of a spoke to rim connector shown in FIG. 3A further illustrating the position of the connector in the spoke and rim fibre layup of the composite wheel.

FIG. 3C provides a further perspective view of a spoke to rim connector shown in FIG. 3A and 3B further illustrating the position of the connector in the spoke and rim fibre layup of the composite wheel.

FIG. 4 provides a perspective view of the spoke to rim connector illustrated in FIGS. 3A to 3C.

FIG. 5A provides a schematic view of a tailored fibre configuration of a Tailor Fibre Placement preform forming a spoke to rim reinforcing connector according to an embodiment of the present invention.

FIG. 5B provides a schematic view of a shaped uniaxial carbon fibre fabric sheet forming a spoke to rim reinforcing connector according to an embodiment of the present invention.

### DETAILED DESCRIPTION

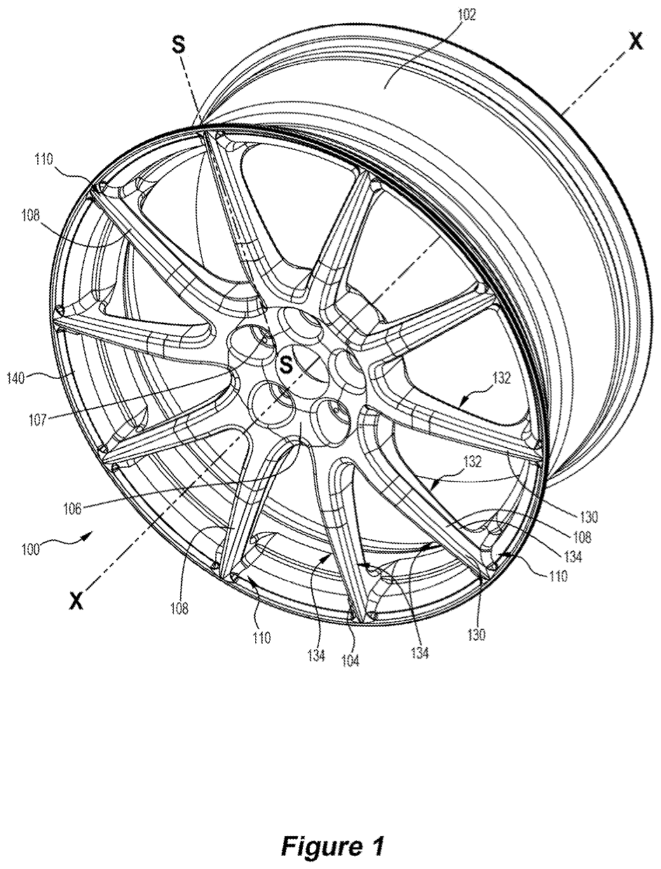

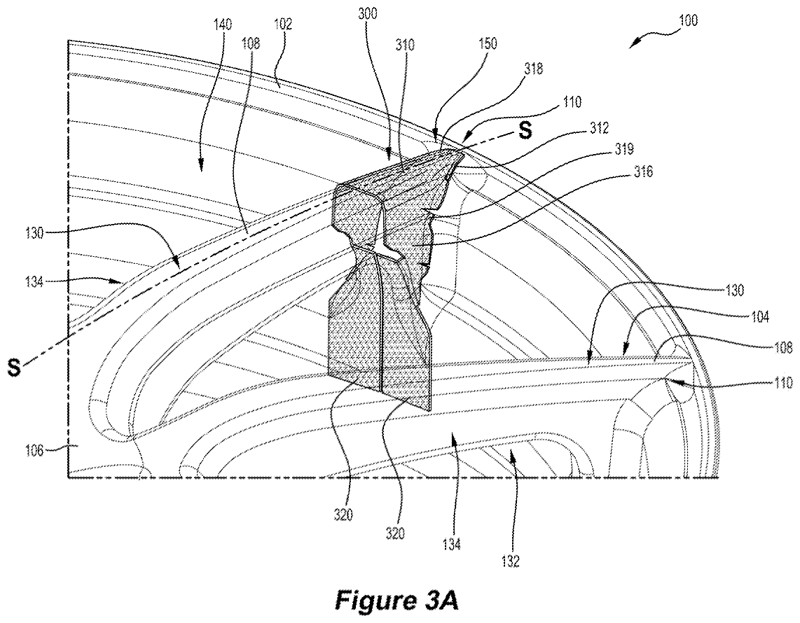

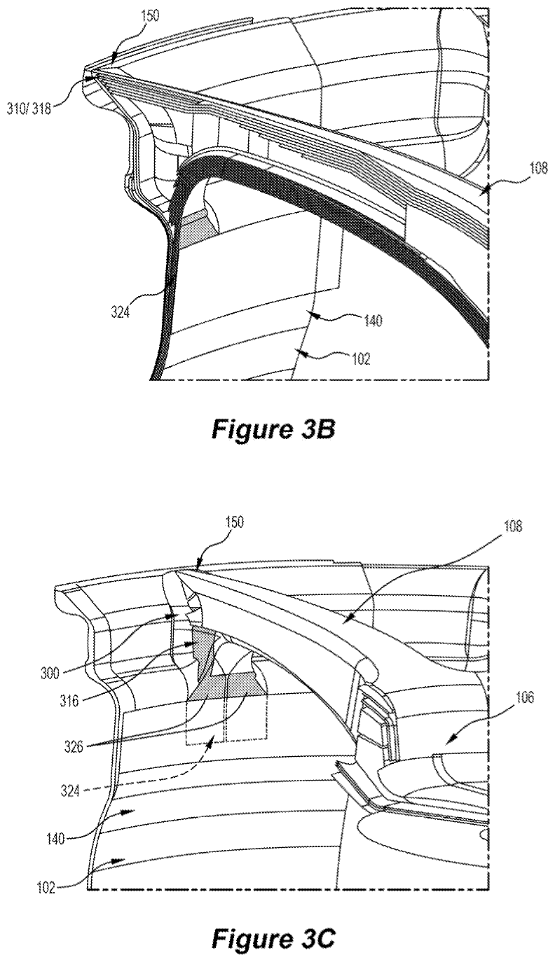

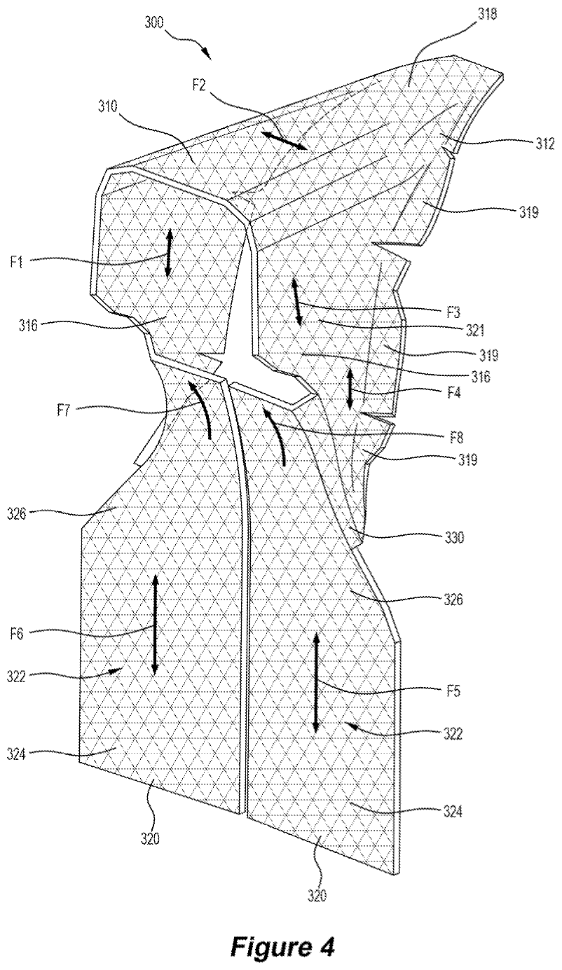

Referring firstly to FIG. 1, there is shown a perspective view of a composite wheel 100 which includes the spoke to rim reinforcing connector 300 (FIG. 3A and 4) of the present invention integrated within the spoke to rim connection 110. The illustrated composite wheel 100 has been developed by the Applicant as being formed as a one-piece body. The general process of manufacture of the composite wheel 100 is described in International Patent Publication No. WO2010/025495A1 and International Patent Publication No. WO2019/033169A1, the contents of which are to be understood to be incorporated into this specification by this reference.

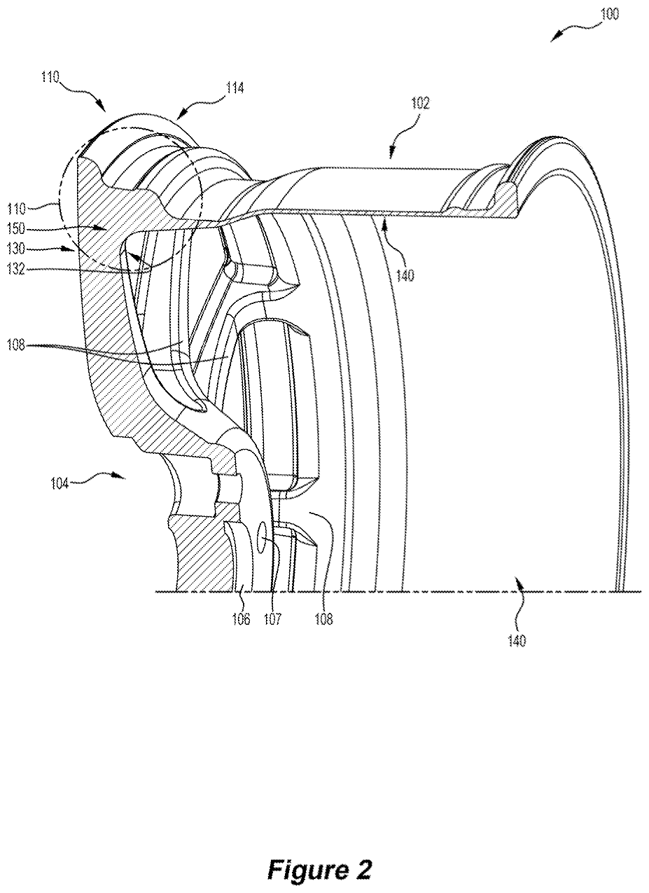

The illustrated composite wheel 100 includes two main sections:
A). a rim portion 102 comprises an annulus shaped structure which circumferentially extends about a wheel axis X-X (FIG. 1) onto which a tyre (not illustrated) is mounted; and
B). a face portion 104 (FIG. 2) comprising a circular hub 106 and a series of spokes 108. The hub 106 includes five fastening apertures 107 configured to receive fastening bolts (not illustrated) used to fix the wheel to a wheel mount of a vehicle. The spokes 108 comprise elongate arms connected to the hub 106 at one end and the rim portion 102 at another end and extend generally along and about a spoke axis S-S (FIGS. 1 and 3). Each spoke 108 has an outwardly extending face surface 130, an opposing back surface 132 and side surfaces 134. It should be appreciated that whilst the illustrated hub 106 and wheel configuration has five fastening apertures, the hub 106 of the composite wheel 100 could have other configurations, for example having a different number of fastening apertures (such as four, six or more) or may comprise a centerlock wheel with a central fastening aperture.

The rim portion 102 has a complementary shaped and configured fibre layup therein and the face portion 104 and comprising spokes 108 have a complementary shaped and configured fibre layup therein. The fibre layup provides a reinforcing skeleton and fibre structure about which the composite wheel 100 can be moulded and mirrors the surfaces and shapes described above for those sections of the carbon fibre wheel. Parts and locations of the fibre layup of the rim portion 102, face portion 104 and spokes 108 will therefore be described in the context of the comprising part of the composite wheel 100 in this patent specification.

As described in International Patent Publication No. WO2010/025495A1, the creation of such a moulded one-piece composite wheel 100 necessitates use of a separate rim portion mould (not illustrated) and face portion mould (not illustrated).

In some embodiments, in use, the rim portion 102 is formed by laying up a first set of fibres typically embodied in a reinforcement fabric seated in the rim portion mould, and the face portion 104 is formed by separately laying up a second set of fibres, typically embodied in a reinforcement fabric seated in the face portion mould. The reinforcement fabric from the rim portion mould and face portion mould are then assembled together in a combined mould, with the separate portions being interconnected at a connection point 110 with the connection between the rim portion 102 and face portion 104 being laid up with reinforcement. After forming the connection, a resin is injected and/or impregnated into the reinforcement of each of the rim portion 102, the face portion 104 of the wheel 100 and then allowed to cure to produce a moulded single piece wheel 100.

It should be appreciated that in other embodiments, the rim portion 102 can be formed as a stacked laminate formed from alternating layers of: a hoop tow layer formed from at least one annularly wound elongate fibre tow; and a bias ply layer as taught in the Applicant's International Patent Publication No. WO2019/033169A1, the contents of which should be understood to be incorporated into this specification by this reference. As described in that specification, the face portion 104 is interconnected to the rim portion 102 whilst laying up the rim portion 102. The fibre layup of the rim portion 102 is also laid up after the face portion 104 layup is completed so that the connection between the face portion 104 and the rim portion 102 can be included directly in the fibre layup of the rim portion 102. As described in WO2019/033169A1, the face portion 104 is laid up with reinforcement with connection sections or tabs. The connection sections from the face portion 104 layup are laid onto and into the fibre layup of the rim portion to form the rim portion to face portion interconnection.

A mechanically efficient connection between the rim portion 102 and face portion 104, and in particular each spoke to rim connection 110 is important to provide stiffness and strength to the wheel 100. In this respect, lateral, vertical and torsional loads are transmitted through a tyre to the rim portion 102 of the wheel 100. These loads transmit bending and torsional stresses through the spokes 108 that need to be resolved efficiently at each spoke to rim connection 110.

The spoke to rim connection 110 of the present invention is formed through the interconnection of the rim reinforcement and face reinforcement of the rim portion 102 and the spoke 108 of the face portion 104 of the composite wheel 100 which is reinforced with the spoke to rim reinforcing connector 300 of the present invention. This connection 110 is shown in more detail in FIGS. 2 and 3.

Referring firstly to FIG. 2, there is shown a more detailed view of the spoke to rim connection 110 of the composite wheel 100 shown in FIG. 1. Externally, the connection region 110 is orientated with the outer surface 114 of the rim portion 102 and is configured to blend into that configuration.

Referring now to FIGS. 3 and 4, there is shown a schematic representation of the positioning of one embodiment of the spoke to rim reinforcing connector 300 within connection 110 between the rim portion 102 and the face portion 104 of the composite wheel 100 shown in FIGS. 1 and 2. The illustrated spoke to rim reinforcing connector 300 comprises two distinct sections which extend through adjacent sections of the fibre layup of the rim portion 102 and the spoke section 108 of composite wheel 100 as follows:
(1) A spoke saddle 310 wrapping around the end section 150 of the fibre layup of spoke 108. The spoke saddle 310 comprises a top spoke seat portion 312 which extends around the fibre layup of end section 150 of spoke 108 generally circumferentially about the spoke axis S-S and over the fibre layup of face surface 130 of the spoke 108 and at least two spoke legs 316 that extend over the sides 134 of the fibre layup of spoke 108 and generally perpendicularly away from the fibre layup of face surface 130 of the spoke 108; and
(2) Two rim tabs 320 which extend from a spoke leg 316 of the spoke saddle 310 generally perpendicularly to the spoke axis S-S to be aligned with the fibre layup of inner surface 140 of rim portion 102 of the composite wheel 100. Each rim tab 320 includes a planar face 322 which is orientated about 90 degrees to a planar face 321 of the spoke legs 316 from which the rim tab 320 is connected to and extends from. Each rim tab 320 is positioned and configured to be incorporated into the fibre layup of the rim portion 102 of the composite wheel 100.

As shown in FIGS. 3A, 3B and 3C, each spoke saddle 310 is located at and over or within the fibre layup of end section 150 of the spoke 108 located at the connection region 110 between the rim portion 102 and spoke portion 108 of the composite wheel 100. Each spoke saddle 310 can be located over all of the layers of the fibre layup of end section 150 or may be incorporated under one or more layers within the fibre layup of end section 150 of the spoke 108. In most cases, the spoke saddle 310 is located as close to the top layer of the fibre layup as practical. The connector 300 is therefore located at the outboard end of the fibre layup of the spoke 108 where the load transfer between the rim and face structures are required. The spoke to rim reinforcing connector 300 has a continuous configuration position on and within the fibre layup of the connection region 110 that starts in the inner surface 140 of rim portion 102 (the first rim tab 320), wraps around the face surface 130 of the spoke 108 (the spoke saddle 310), and ends back in the inner surface 140 of the rim portion 102 (the second rim tab 320). As shown in FIGS. 3B and 3C, the spoke saddle 310 is integrated into the fibre layup of the end portion 150 of spoke 108.

As best shown in FIG. 4, each of the spoke saddle 310 and rim tabs 320 are formed from a substantially planar sheet of material. However, it should be appreciated that in other embodiments the spoke to rim reinforcing connector can also be formed from multiple plies of materials, each having the described and illustrated configuration. The illustrated spoke saddle 310 comprises a planar body wrapped around the fibre layup of the sides 134 and the face surface 130 of the end section 150 of a spoke 108. The spoke saddle 310 forms a generally arched shape over the fibre layup of the spoke 108. The illustrated spoke saddle 310 includes a generally rectangular shaped (or if an end portion near the rim portion 102 is considered—perhaps a slight trapezoidal shaped) top section 318 shaped to cover a portion of the fibre layup of the face surface 130 of the spoke 107 proximate where the spoke 108 connects to the rim portion 102. The spoke legs 316 of each spoke saddle 310 have a generally triangular shape. FIG. 3B shows the top section 318 within the fibre layup of spoke section 108.

As best shown in FIGS. 3A and 4, each spoke leg 316 also include a series of edge flange portions 319 configured to extend at an angle outwardly of the face 321 of the spoke legs 316 and towards the fibre layup of the inner surface 140 of the rim portion 102 of the composite wheel 100. The edge flange portions 319 assists in load transfer between the rim portion 102 and the side surfaces 134 of the spoke 108 and the spoke face 130.

Each rim tab 320 also comprises a substantially planar body configured to be generally parallel aligned with the inner surface 140 and fibre layup thereof of the annular body of the rim portion 102 of the composite wheel 100. Each of the rim tabs 320 is configured to be integrated into the fibre layup or the rim portion 102 of the composite wheel 100.

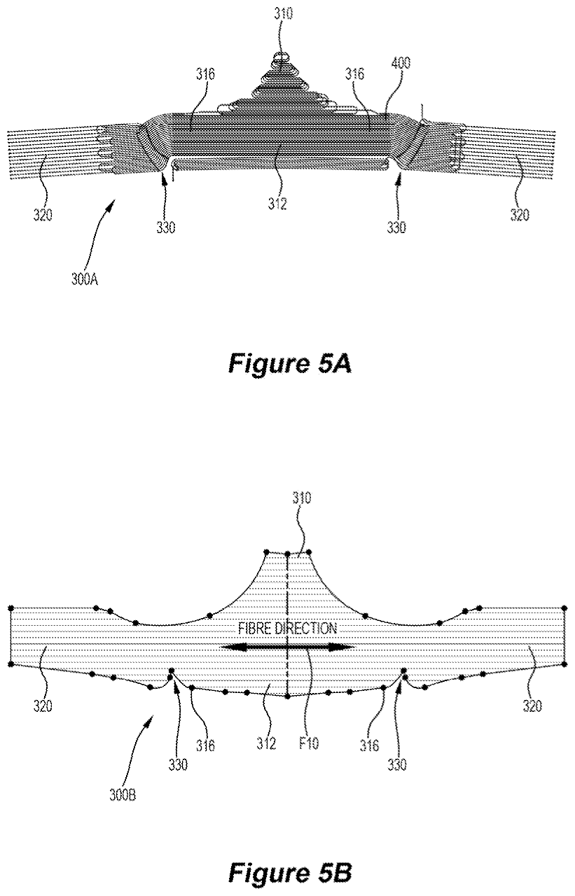

The illustrated rim tabs 320 comprise a generally rectangular body 324 connected to a trapezoidal shaped spoke section 326. Each rim tab 320 is connected to the respective spoke leg 316 through an integral joint 330 (FIG. 5A), formed as a bend or fold line, about which each rim tab 320 is angled around 90 degrees relative to the face 321 of the spoke legs 316.

As shown in FIGS. 3B and 3C, the rim tabs 320 and more particularly the generally rectangular body 324 of rim tabs 320 is integrated into the fibre layup of the rim portion 102. Similarly, the spoke saddle 310 is integrated into the fibre layup of the end portion 150 of spoke 108.

The configuration of each rim tab 320 enables each rim tab 320 to wrap around the fibre layup at the back surface 132 of each spoke 108, to complete coverage around the spoke 108 from the fibre layup of the inner surface 140 of the rim portion 102 under the fibre layup of the each spoke 108, through to the fibre layup of the back surface 132 of each spoke 108. As shown in FIG. 3A, 3B and 3C, each rim tab 320 is configured to abut an adjacent rim tab 320 under the fibre layup of the back surface 132 of the spoke 108 to form a continuous cover.

The trapezoidal shaped spoke section 326 of each rim tab 320 is configured to curve towards the fibre layup of the back surface 132 of the spoke 108 (and fibre layup thereof) wrapping around at least part of the fibre layup of the back surface 132 to allow a transition of the fibre orientation (as shown by curved arrows F7 and F8 in FIG. 4) in the spoke section 326 from substantially perpendicular to the spoke axis S-S towards becoming more spoke axis S-S aligned in the distal portion of the spoke section 326. In some embodiments (not illustrated) that distal portion of the spoke section 326 can be configured to be aligned with the back surface 132 of the spoke 108 (and fibre layup thereof). However, in the illustrated embodiment, the distal portion of the spoke section 326 ends only part way up the transition curve to the back surface 132 of the spoke 108 (and fibre layup thereof).

The fibre orientation within the connector 300 is configured so that the comprising fibres are orientated substantially perpendicular to the spoke axis S-S in the spoke saddle 310 and rim tabs 320 forming the connector 300, as indicated by fibre direction arrows F1 to F6 (FIG. 4). The connector 300 therefore has continuous fibre orientation therethrough that extends substantially perpendicular to the spoke axis S-S that starts in the rim portion 102 (rim tab 320), wraps around the face of the spoke 108 (spoke saddle 310), and ends back in the rim portion 102 (rim tab 320). Moreover, when the transitional fibre orientation (F7 and F8) of the spoke section 326 is considered, the fibre orientation of the connector 300 is perpendicular to the spoke axis S-S in the spoke saddle 310 of the connector 300. The fibre orientation of the connector 300 is also perpendicular to the spoke axis S-S in the face portion 322 of the rim tabs 320. However, the fibre orientation of the connector 300 then wraps around the back of spoke radius in such a way that the fibre orientation F7 and F8 transitions to become more spoke aligned in the spoke section 326 of rim tab 320 of the connector 300.

This fibre orientation can be formed in any suitable manner. Two embodiments of the connector 300 showing fibre orientation are illustrated in FIGS. 5A and 5B.

FIG. 5A shows a Tailor Fibre Placement (TFP) preform form 300A of the spoke to rim reinforcing connector 300. This embodiment uses tailor fibre placement technology to enable optimal fibre alignment and thickness changes to form fibre layout 400. This ensures the fibre direction is maintained through the preforming and layup operations.

As shown in FIG. 5B, the spoke to rim reinforcing connector 300B may be alternatively formed from uniaxial fabric having fibre direction F10 which is cut into the appropriate shape and configuration, and then shaped as shown in FIGS. 3 and 4. Any appropriate uniaxial fabric arrangements could be used, such as stitch bonded, or weft stabilised uniaxial fabrics.

As discussed previously, the spoke to rim reinforcing connector is typically formed as an integral body, formed from a single ply of material. However again it should be appreciated that in embodiments the spoke to rim reinforcing connector can also be formed from multiple plies of materials, each having the described configuration.

As previously noted, the Applicant's composite wheel 100 illustrated in FIGS. 1, 2 and 3 is preferably formed as an integrally formed composite wheel, with the rim portion 102 and face portion 104 of the composite wheel 100 integrally formed and connected. The connection portion 110 and the spoke to rim reinforcing connector 300 therein is also integrally formed with the composite wheel 100.

The illustrated spoke to rim reinforcing connector 300 is used to reinforce the connection portion 110 of the spoke to rim connection of composite wheel 100 by laying up the connection between the rim portion 102 and face portion 104 of that composite wheel 100.

For example, as described in the Applicant's International Patent Publication No. WO2019/033169A1, the face portion 104 is interconnected to the rim portion 102 using a connection architecture that is included in the face portion 104 layup and then integrated into the rim portion 102 layup during the subsequent layup process. The fibre layup of the rim portion 102 is also laid up after the face portion 104 layup is completed so that the connection between the face portion 104 and rim portion 102 can be included directly in the fibre layup of the rim portion 102. The face portion 104 fibre layup has a selected carbon fibre layup which includes a generally circular shaped hub 106 and a plurality of spokes 108 which extend along spoke axis S-S from the hub 106 and a connection sections or tabs (not illustrated). The connection sections from the face portion 104 layup are laid onto and into the fibre layup of the rim portion 102 to form the rim portion to face portion interconnection. During this process, the spoke to rim connector 300 is integrated into the layup of the face portion 104. positioning the spoke saddle 310 of each connector 300 within the layup of the end section 150 of each spoke 108 in the desired layer (in many cases close to the top or upper layer of that layup), and each rim tab 320 in alignment with the fibre layup of the rim portion 102 of the composite wheel 100. An annular mould tool (not illustrated) shaped to provide the designed configuration of the rim portion 102 is provided, and the connection sections and rim tabs 320 are laid into that annular mould tool. The fibre layup and architecture of the rim portion 102 is then laid up to incorporate each rim tab 320 therein.

Whilst the illustrated embodiments show the positioning of a single spoke to rim reinforcing connector 300 in the connection portion 110 of the spoke to rim connection of composite wheel 100, it should be appreciated that the spoke fibre layup in the face portion 104 layup can include one or more spoke to rim reinforcing connectors 300 within those layers. In embodiments, multiple spoke to rim reinforcing connectors 300 are included in that layup. For example, three spoke to rim reinforcing connectors 300 could be respectfully positioned at the bottom, middle and top of the spoke fibre layup of the face portion 104.

The fibre layup or fibre architecture of the rim portion 102 and face portion 104 comprises a multi-layered structure. The number of layers may vary considerably depending on the design of the rim portion 102 and the size and type of composite members. In some embodiments, one or more layers can be used, for example only a few layers, such as 4 to 10 layers, or 4 to 20 layers, for example, 4, 6, 8, 10, 12, 14, 16, 18 or 20 layers can be used. In other embodiments, a higher number, for example 20, 30, 50, 100 or more layers are needed to obtain the desired quality and/or properties of the rim portion 102.

It should be appreciated that a wide variety of fibres may be used in the present invention, including but not limited to fibres selected from the group consisting of carbon fibres, glass fibres, aramid fibres, synthetic fibres such as acrylic, polyester, PAN, PET, PE, PP or PBO-fibres, or the like, bio fibres such as hemp, jute, cellulose fibres, or the like, mineral fibres for example Rockwool or the like, metal fibres for example steel, aluminium, brass, copper, or the like, boron fibres or any combination of these. In a preferred embodiment, the fibres comprise carbon fibres.

The fibre volume fraction in carbon fibre layer can be controlled by forming the various layers out of materials of a selected fibre areal weight. The fibre areal weight in each layer is from 50 to 400 g/m², preferably from 180 to 250 g/m², more preferably from 180 to 220 g/m², yet more preferably about 200 g/m².

The illustrated composite wheel 100 (FIG. 1) is intended to be formed as a unitary body. This involves simultaneous injection and/or impregnation of a matrix material, which in the exemplary embodiment is a resin, into all parts including the rim portion 102, face portion 104 and connection portion 110 (including the spoke to rim reinforcing connector 300) and then curing of each of the portions of the composite wheel 100. The resin used is preferably epoxy-based. However, it should be understood that any suitable resin can be used for example unsaturated polyester, polyurethane, polyvinyl ester, epoxy, thermoplastics, similar chemical compounds or combinations thereof. A variety of resin delivery systems can be used including, but not limited to Resin Infusion and/or Resin Transfer Moulding and/or Vacuum Assisted Resin Transfer Moulding.

The formed rim portion 102 and face portion 104 of the composite wheel 100 therefore also comprises a matrix material enveloping the fibres of the stacked laminate, typically a resin based on unsaturated polyester, polyurethane, polyvinyl ester, epoxy, thermoplastics, similar chemical compounds or combinations thereof. However, it should be appreciated other matrix materials may also be applicable.

After forming the connection, a resin is injected and/or impregnated into the reinforcement of each of the rim portion 102, the face portion 104 and connection of the wheel and then allowed to cure.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps, components or group(s) thereof.

1-31. (canceled)

32. A spoke to rim reinforcing connector of a composite wheel,
the composite wheel having a rim portion comprising a shaped annulus formed about a central axis of rotation of the composite wheel and having a circumferential axis extending circumferentially about the central axis and around the rim portion, and a face portion comprising a circular shaped hub and a plurality of spokes which extend along a spoke axis that extends radially to the circumferential axis, the plurality of spokes extending between the rim portion and the hub to interconnect the rim portion and the hub, each spoke having an outwardly extending face surface, an opposing back surface and side surfaces therebetween,
the rim portion has a complementary rim fibre layup therein and each spoke has a complementary spoke fibre layup therein,
the spoke to rim reinforcing connector comprising:
at least one spoke saddle comprising a seat portion which extends around an end portion of the spoke fibre layup about the spoke axis and over the face surface of the spoke fibre layup, and at least two spoke legs that extend over the sides of the spoke fibre layup; and
at least two rim tabs, each rim tab extending from a spoke leg perpendicularly to the spoke axis, each rim tab configured to be incorporated into the rim fibre layup of the rim portion of the composite wheel,
wherein the connector comprises a continuous body having a fibre orientation that extends perpendicular to the spoke axis.

33. The spoke to rim reinforcing connector according to claim 32, wherein the connector has a continuous fibre orientation therethrough that extends perpendicular to the spoke axis.

34. The spoke to rim reinforcing connector according to claim 32, wherein each rim tab comprises a planar body configured to be parallel aligned with the annular body of the rim fibre layup of the rim portion of the composite wheel.

35. The spoke to rim reinforcing connector according to claim 32, wherein the spoke saddle comprises a planar body wrapped around the sides and face surface of the end portion of the spoke fibre layup of a spoke, and the planar body of each rim tab optionally includes a planar face which is orientated 90 degrees to a planar face of the spoke legs from which the rim tab is connected to and extends from.

36. The spoke to rim reinforcing connector according to claim 32, wherein each rim tab is configured to abut an adjacent rim tab under the back surface of the spoke fibre layup of the composite wheel, and adjoining rim tabs are optionally configured to form a continuous cover that extends over the section of the rim fibre layup under the back surface of the spoke of the composite wheel.

37. The spoke to rim reinforcing connector according to claim 32, wherein each rim tab includes a spoke section configured to extend along a portion of the rim fibre layup of the rim portion that is adjacent to and under the back surface of the spoke of the composite wheel.

38. The spoke to rim reinforcing connector according to claim 37, wherein the spoke section of each rim tab, preferably a top section of each rim tab, is configured to curve towards a back surface of the spoke fibre layup of the composite wheel.

39. The spoke to rim reinforcing connector according to claim 37, wherein the spoke section of each rim tab is curved to wrap around the back surface of the spoke fibre layup to facilitate the transition of the fibre orientation in the spoke section from perpendicular to the spoke axis toward being more spoke axis aligned.

40. The spoke to rim reinforcing connector according to claim 32, wherein each rim tab comprises a rectangular body connected to a trapezoidal shaped spoke section.

41. The spoke to rim reinforcing connector according to claim 32, wherein each rim tab is connected to the respective spoke leg through a joint about which each rim tab is angled between 80 to 100 degrees, optionally around 90 degrees relative to the face of the spoke legs, wherein each joint preferably comprises at least one fold line or bend line.

42. The spoke to rim reinforcing connector according to claim 32, wherein each spoke saddle comprises a curved, optionally arched shaped planar sheet.

43. The spoke to rim reinforcing connector according to claim 32, wherein each spoke leg extends perpendicularly away from the face surface of the spoke fibre layup of the spoke.

44. The spoke to rim reinforcing connector according to claim 32, wherein the spoke legs include at least one edge flange portion which is configured to extend at an angle outwardly of the face of the spoke legs and towards the rim fibre layup of the composite wheel.

45. The spoke to rim reinforcing connector according to claim 32, wherein each spoke seat is located at and over the proximal end of the spoke fibre layup located at an interface between the rim portion and spoke portion of the composite wheel.

46. The spoke to rim reinforcing connector according to claim 32, wherein the spoke legs of each spoke saddle have a triangular shape.

47. The spoke to rim reinforcing connector according to claim 32, wherein the spoke seat of each spoke saddle includes a top section shaped to cover a portion of the top face of the spoke fibre layup proximate where the spoke connects to the rim portion, the top section of the spoke seat having a rectangular or trapezoidal shape.

48. The spoke to rim reinforcing connector according to claim 32, wherein the spoke to rim reinforcing connector comprises a fabric sheet, preferably a uniaxial carbon fibre fabric sheet, wherein the spoke to rim reinforcing connector preferably comprises an integral or continuous uniaxial carbon fibre fabric.

49. The spoke to rim reinforcing connector according to claim 32, wherein the spoke to rim reinforcing connector comprises at least one tailored fibre preform having a desired shape and fibre orientation, wherein the spoke to rim reinforcing connector preferably comprises a Tailor Fibre Placement (TFP) preform.

50. A connection between a rim portion and a face portion of a composite wheel having a fibre layup that includes at least one spoke to rim reinforcing connector according to claim 32, wherein the connection optionally includes one of:
each of the rim portion and the face portion is at least partially uncured at the time when the connection is prepared; or
the connection further comprises a matrix material comprising a resin based on unsaturated polyester, polyurethane, polyvinyl ester, epoxy, thermoplastics, similar chemical compounds or combinations thereof enveloping the fibre layup thereof.

51. A composite wheel including a spoke to rim reinforcing connector according to claim 32, wherein the composite wheel optionally comprises a carbon fibre wheel.

52. A composite wheel including a connection according to claim 50, wherein the composite wheel optionally comprises a carbon fibre wheel.
